(19) United States
(12) Patent Application Publication
(10) Pub. No.: US 2019/0177193 A1
(43) Pub. Date: Jun. 13, 2019

(54) REMOVING FINE PARTICULATE MATTER FROM FLUID STREAMS

(71) Applicant: Soane Mining, LLC, Palm Beach Gardens, FL (US)

(72) Inventors: David S. Soane, Palm Beach, FL (US); James Nathan Ashcraft, Jupiter, FL (US); Allison Silverstone, Hillsboro Beach, FL (US)

(21) Appl. No.: 16/211,667

(22) Filed: Dec. 6, 2018

Related U.S. Application Data
(63) Continuation of application No. PCT/US17/26921, filed on Apr. 11, 2017.
(60) Provisional application No. 62/346,860, filed on Jun. 7, 2016.

(51) Int. Cl. C02F 1/56; C02F 1/52

(52) U.S. Cl. CPC C02F 1/56; C02F 2103/10; C02F 1/5236

(57) ABSTRACT

The invention is directed to methods of removing particulate matter from a fluid as a hydrophobized composite, comprising: providing an activating material capable of being affixed to the particulate matter wherein the activating material is an anionic or a cationic polymer; affixing the activating material to the particulate matter to form activated particles in the fluid; providing anchor particles and providing a tethering material capable of being affixed to the anchor particles, wherein the tethering material is a cationic or an anionic polymer; attaching the tethering material to the anchor particles to form tether-bearing anchor particles and adding the tether-bearing anchor particles to the fluid, wherein the tethering material attaches to the activated particles to form removable complexes in the fluid; removing the removable complexes from the fluid, thereby removing the particulate matter from the fluid; and adding a hydrophobizing material at one or more of the preceding steps, thereby removing the particulate matter from the fluid as the hydrophobized composite.

### RELATED APPLICATIONS

This application is a continuation of International Application No. PCT/US17/26921, which designated the United States and was filed on Apr. 11, 2017, published in English, which claims the benefit of U.S. Provisional Application No. 62/346,860, filed on Jun. 7, 2016. The entire teachings of the above applications are incorporated by reference herein.

### FIELD OF THE APPLICATION

This application relates to methods for removing finely dispersed particulate matter from fluid streams.

### BACKGROUND

Fine materials generated from mining activities are often found well-dispersed in aqueous environments, such as process water and wastewater. The finely dispersed materials may include such solids as various types of clay materials, recoverable materials, fine sand and silt. Separating these materials from the aqueous environment can be difficult, as they tend to retain significant amounts of water, even when separated out, unless special energy-intensive dewatering processes or long-term settling practices are employed. In addition, certain industrial processes can create waste streams of large-particle inorganic solids. A typical approach to consolidating fine materials dispersed in water involves the use of coagulants or flocculants. This technology works by linking together the dispersed particles by use of multivalent metal salts (such as calcium salts, aluminum compounds or the like) or high molecular weight polymers such as partially hydrolyzed polyacrylamides. Additionally, natural calcium carbonate, modified calcium carbonate, or surface modified calcium carbonate can be used to link or aggregate fine particles. With the use of these agents, there is an overall size increase in the suspended particle mass; moreover, their surface charges are neutralized, so that the particles are destabilized. The overall result is an accelerated sedimentation of the treated particles. Following the treatment, though, a significant amount of water remains trapped with the sedimented particles. These technologies typically do not release enough water from the sedimented material that the material becomes mechanically stable. In addition, the substances used for flocculation/coagulation may not be cost-effective, especially when large volumes of wastewater require treatment, in that they require large volumes of flocculant and/or coagulant. While ballasted flocculation systems have also been described, these systems are inefficient in sufficiently removing many types of fine particles that are produced in mining.

An example of a high-volume water consumption process is the processing of naturally occurring ores, as may be found in mining operations. Naturally occurring ores are heterogeneous mixtures of materials including the target product plus a multitude of solid inorganic materials, such as clays, silts, sands, waste rock and smaller quantities of organic materials. During the processing of such ores, colloidal particles, such as clay and mineral fines, are released into the aqueous phase often due to crushing, grinding, milling, and/or the introduction of mechanical shear. In addition to mechanical energy inputs, various beneficiation reagents including collectors, depressants, frothers, and flotation aids are sometimes added during extraction, creating an environment more suitable for colloidal suspensions. A common method for disposal of the resulting “tailings” solutions, which contain fine colloidal suspensions of clay and minerals, water, residual beneficiation chemicals and small amounts of the remaining product, is to store them in “tailings ponds”. These ponds take years to settle out the contaminating fines, making the water unsuitable for recycling.

One approach to consolidating fine materials dispersed in water involves the use of coagulants or flocculants. This technology works by linking together the dispersed particles by use of multivalent metal salts (such as calcium salts, aluminum compounds or the like) or high molecular weight polymers such as partially hydrolyzed polyacrylamides. Additionally, natural calcium carbonate, modified calcium carbonate, or surface modified calcium carbonate can be used to link or aggregate fine particles. With the use of these agents, there is an overall size increase in the suspended particle mass; moreover, their surface charges are neutralized, so that the particles are destabilized. The overall result is an accelerated sedimentation of the treated particles. Following the treatment, though, a significant amount of water remains trapped with the sedimented particles. These technologies typically do not release enough water from the sedimented material that the material becomes mechanically stable. In addition, the substances used for flocculation/coagulation may not be cost-effective, especially when large volumes of wastewater require treatment, in that they require large volumes of flocculant and/or coagulant. While ballasted flocculation systems have also been described, these systems are inefficient in sufficiently removing many types of fine particles. Other processes and equipment that are used in solids dewatering include thickeners, centrifuges, gravity filters, belt filters, and filter presses. These are different ways to mechanically separate water from the solids, and they are often used in conjunction with a flocculant and/or coagulant, which works to chemically promote the clumping of fine particles.

An additional need in the art pertains to the management of existing tailings ponds. In their present form, they are environmental liabilities that may require extensive clean-up efforts in the future. It is desirable to prevent their expansion. It is further desirable to improve their existing state, so that their contents settle more efficiently and completely. A more thorough and rapid separation of solid material from liquid solution in the tailings pond could allow retrieval of recyclable water and compactable waste material, with an overall reduction of the footprint that they occupy.

A technology useful for addressing these problems has been set forth in co-owned U.S. Pat. Nos. 8,353,641, and 8,557,123 “Methods for Removing Finely Dispersed Particulate Matter from a Fluid Stream,” and U.S. Pat. Nos. 8,349,188, and 8,945,394, the contents of each of which are incorporated by reference in their entirety.

These patents disclose methods and apparatus for removing finely dispersed particulate matter from fluid streams, for example, the aqueous streams that carry mining waste. The methods disclosed include a two-component system: an “activator” polymer that interacts with the fine particulate matter in the aqueous stream to complex with the fines, or “activate” them, and a formed complex of polymer-coated, coarser particulate matter called “tether-bearing anchor particles,” where the coarser particles, termed “anchor” particles, have been coated or functionalized with a “tether” polymer that has been selected to have an affinity for the activated fines. Because of the interaction of the tether polymers and the activator polymers, the tether-bearing anchor particles, when mixed with the activated fines, interact very rapidly to form durable complexes that can be readily removed from the fluid. These durable complexes consolidate tightly and strongly, while the aqueous fluid around them is easily separated for recycling. These interactions, termed the “anchor-tether-activator” or “ATA” process, can be applied to the treatment of tailings ponds or mining waste.

Mining waste treatment offers a particularly attractive target for ATA treatment, because successful treatment of tailings as they are produced at the mine can obviate the need for new tailings ponds. When live tails are produced at the mine site, the coarser tailings particles are typically separated from the fine tailings stream as part of the waste treatment process. These systems for processing tailings intersect well with the ATA treatment process. For mining waste treatment using the ATA system, coarse tailings can provide a source of anchor particles to be treated with the tether polymer, while the fine tailings are treated with the activator. Following treatment, the two streams are recombined, leading to the formation of a strong, consolidated mass that can be readily separated from clear water for reuse.

It has been demonstrated that ATA can reliably treat live tails to form a durable, low moisture product and recyclable water, and can reduce or eliminate tailings ponds. It would be desirable, however, to improve the solid product that ATA forms so that the water drains from it faster and more completely, thus allowing the solids and liquids to separate more efficiently. It would be further desirable that the consolidated solids be stronger, for example, by being bound more tightly or by having have a higher solids content (as strength generally increases exponentially with increased solids content), so that the consolidated mass would maintain its mechanical properties under conditions of use. This would allow the consolidated solids to be used for weight-bearing applications such as general construction, road-building, dam-building, landfill, and the like. It would also be desirable to have the solids product be more resistant to water ingress. This would enhance the durability of the product in a wet environment, and would allow the solid mass to bind hazardous mine waste more durably so that it does not leach into the environment. Such durably-bound mine solids can resist dissolution in water, which could offer benefits in the control of acid mine drainage and other environmentally damaging mine-related seepage.

### SUMMARY

Disclosed herein, in embodiments, are methods of removing particulate matter from a fluid as a hydrophobized composite, comprising: providing an activating material capable of being affixed to the particulate matter wherein the activating material is an anionic or a cationic polymer; affixing the activating material to the particulate matter to form activated particles in the fluid; providing anchor particles and providing a tethering material capable of being affixed to the anchor particles, wherein the tethering material is a cationic or an anionic polymer; attaching the tethering material to the anchor particles to form tether-bearing anchor particles and adding the tether-bearing anchor particles to the fluid, wherein the tethering material attaches to the activated particles to form removable complexes in the fluid; removing the removable complexes from the fluid, thereby removing the particulate matter from the fluid; and adding a hydrophobizing material at one or more of the preceding steps, thereby removing the particulate matter from the fluid as the hydrophobized composite. In embodiments the hydrophobizing material is added to the fluid prior to the step of affixing the activating material. In embodiments, the hydrophobizing material is added to the activating material. In embodiments, the hydrophobizing material is added to the activated particles after their formation. In embodiments, the hydrophobizing material comprises hydrophobic particles. In embodiments, the hydrophobic particles are used as anchor particles. In embodiments, the hydrophobic particles are intrinsically hydrophobic. In embodiments, the hydrophobic particles comprise a substrate having a hydrophobic modification. In embodiments, the substrate comprises calcium carbonate, which can be a precipitated calcium carbonate. In embodiments, the hydrophobizing material is added to the fluid prior to the step of adding the tether-bearing anchor particles. In embodiments, the hydrophobizing material is added to the fluid at substantially the same time as the tether-bearing anchor particles are added. In embodiments, the hydrophobizing material is added to the fluid after the addition of the tether-bearing anchor particles. In embodiments, the hydrophobizing material is added to the removable complexes before, during, or after their removal. In embodiments, the hydrophobizing material is added to the removable complexes after their removal as a post-treatment modification. In embodiments, the hydrophobizing material comprises an emulsion. Further disclosed are hydrophobized composites prepared by the aforesaid methods.

### DETAILED DESCRIPTION

The ATA technology can be significantly improved by increasing the hydrophobicity of the formed ATA product. Over the basic ATA process, the hydrophobized ATA process can provide a hydrophobic form of the ATA product that has increased solids content and stability. The hydrophobized ATA process can facilitate water drainage from the product, yielding recyclable water more quickly and allowing more complete consolidation of the solid mass.

### 1. ATA Process Generally

The ATA process has been generally described in U.S. Pat. Nos. 8,353,641, 8,557,123, 8,349,188, and 8,945,394, the contents of each of which are incorporated by reference in their entirety. Generally, these processes employ three subprocesses: (1) the “activation” of the wastewater stream bearing the fines by exposing it to a dose of a flocculating polymer that attaches to the fines; (2) the preparation of “anchor particles,” fine particles such as sand by treating them with a “tether” polymer that attaches to the anchor particles; and (3) combining the tether-bearing anchor particles and the activated wastewater stream containing the fines, so that the tether-bearing anchor particles form complexes with the activated fines. The activator polymer and the tether polymer have been selected so that they have a natural affinity with each other. Combining the activated fines with the tether-bearing anchor particles rapidly forms a solid complex that can be separated from the suspension fluid, resulting in a stable mass that can be easily and safely stored, along with clarified water that can be used for other industrial purposes. Following the separation process, the stable mass can be used for beneficial purposes, as can the clarified water. As an example, the clarified water could be recycled for use on-site in further processing and beneficiation of ores. As an example, the stable mass could be used for construction purposes at the mine operation (roads, walls, etc.), or could be used as a construction or landfill material offsite. Dewatering to separate the solids from the suspension fluid can take place in seconds, relying only on gravity filtration.

a. Activation

As used herein, the term “activation” refers to the interaction of an activating material, such as a polymer, with suspended particles in a liquid medium, such as an aqueous solution. In embodiments, high molecular weight polymers can be introduced into the particulate dispersion, so that these polymers interact, or complex, with fine particles. The polymer-particle complexes interact with other similar complexes, or with other particles, and form agglomerates. This “activation” step can function as a pretreatment to prepare the surface of the fine particles for further interactions in the subsequent phases of the disclosed system and methods. For example, the activation step can prepare the surface of the fine particles to interact with other polymers that have been rationally designed to interact therewith in an optional, subsequent “tethering” step, as described below. Not to be bound by theory, it is believed that when the fine particles are coated by an activating material such as a polymer, these coated materials can adopt some of the surface properties of the polymer or other coating. This altered surface character in itself can be advantageous for sedimentation, consolidation and/or dewatering. In another embodiment, activation can be accomplished by chemical modification of the particles. For example, oxidants or bases/alkalis can increase the negative surface energy of particulates, and acids can decrease the negative surface energy or even induce a positive surface energy on suspended particulates. In another embodiment, electrochemical oxidation or reduction processes can be used to affect the surface charge on the particles. These chemical modifications can produce activated particulates that have a higher affinity for tethered anchor particles as described below. Particles suitable for modification, or activation, can include organic or inorganic particles, or mixtures thereof. Inorganic particles can include one or more materials such as calcium carbonate, dolomite, calcium sulfate, kaolin, talc, titanium dioxide, sand, diatomaceous earth, aluminum hydroxide, silica, other metal oxides and the like.

The “activation” step may be performed using flocculants or other polymeric substances. Preferably, the polymers or flocculants can be charged, including anionic or cationic polymers. In embodiments, anionic polymers can be used, including, for example, olefinic polymers, such as polymers made from polyacrylate, polymethacrylate, partially hydrolyzed polyacrylamide, and salts, esters and copolymers thereof (such as (sodium acrylate/acrylamide) copolymers) polyacrylic acid, polymethacrylic acid, sulfonated polymers, such as sulfonated polystyrene, and salts, esters and copolymers thereof, and the like. Suitable polycations include: polyvinylamines, polyallylamines, polydiallyldimethylammoniums (e.g., polydiallyldimethylammonium chloride, branched or linear polyethyleneimine, crosslinked amines (including epichlorohydrin/dimethylamine, and epichlorohydrin/alkylenediamines), quaternary ammonium substituted polymers, such as (acrylamide/dimethylaminoethylacrylate methyl chloride quat) copolymers and trimethylammoniummethylene-substituted polystyrene, polyvinylamine, and the like. Nonionic polymers suitable for hydrogen bonding interactions can include polyethylene oxide, polypropylene oxide, polyhydroxyethylacrylate, polyhydroxyethylmethacrylate, and the like. In embodiments, an activator such as polyethylene oxide can be used as an activator with a cationic tethering material in accordance with the description of tethering materials below. In embodiments, activator polymers with hydrophobic modifications can be used. Flocculants such as those sold under the trademark MAGNAFLOC® by Ciba Specialty Chemicals can be used.

In embodiments, activators such as polymers or copolymers containing carboxylate, sulfonate, phosphonate, or hydroxamate groups can be used. These groups can be incorporated in the polymer as manufactured; alternatively, they can be produced by neutralization of the corresponding acid groups, or generated by hydrolysis of a precursor such as an ester, amide, anhydride, or nitrile group. The neutralization or hydrolysis step could be done on site prior to the point of use, or it could occur in situ in the process stream.

The activated particle can also be an amine functionalized or modified particle. As used herein, the term “modified particle” can include any particle that has been modified by the attachment of one or more amine functional groups as described herein. The functional group on the surface of the particle can be from modification using a multifunctional coupling agent or a polymer. The multifunctional coupling agent can be an amino silane coupling agent as an example. These molecules can bond to a particle surface (e.g., metal oxide surface) and then present their amine group for interaction with the particulate matter. In the case of a polymer, the polymer on the surface of the particles can be covalently bound to the surface or interact with the surface of the particle and/or fiber using any number of other forces such as electrostatic, hydrophobic, or hydrogen bonding interactions. In the case that the polymer is covalently bound to the surface, a multifunctional coupling agent can be used such as a silane coupling agent. Suitable coupling agents include isocyano silanes and epoxy silanes as examples. A polyamine can then react with an isocyano silane or epoxy silane for example. Polyamines include polyallyl amine, polyvinyl amine, chitosan, and polyethylenimine. In embodiments, polyamines (polymers containing primary, secondary, tertiary, and/or quaternary amines) can also self-assemble onto the surface of the particles or fibers to functionalize them without the need of a coupling agent. For example, polyamines can self-assemble onto the surface of the particles through electrostatic interactions. They can also be precipitated onto the surface in the case of chitosan for example. Since chitosan is soluble in acidic aqueous conditions, it can be precipitated onto the surface of particles by suspending the particles in a chitosan solution and then raising the solution pH.

In embodiments, the amines or a majority of amines are charged. Some polyamines, such as quaternary amines are fully charged regardless of the pH. Other amines can be charged or uncharged depending on the environment. The polyamines can be charged after addition onto the particles by treating them with an acid solution to protonate the amines. In embodiments, the acid solution can be non-aqueous to prevent the polyamine from going back into solution in the case where it is not covalently attached to the particle. The polymers and particles can complex via forming one or more ionic bonds, covalent bonds, hydrogen bonding and combinations thereof, for example. Ionic complexing is preferred.

The particles that can be activated are generally fine particles that are resistant to sedimentation. Examples of particles that can be filtered in accordance with the invention include metals, sand, inorganic, or organic particles. The particles are generally fine particles (for example, particles between about 0.1-150 microns in diameter or particles having a mass mean diameter of less than 50 microns or particle fraction that remains with the filtrate following a filtration with, for example, a 325 mesh filter). The particles to be removed in the processes described herein are also referred to as “fines.”

b. Tethering

As used herein, the term “tethering” refers to an interaction between an activated fine particle and an anchor particle (for example, as described below). The anchor particle can be treated or coated with a tethering material. The tethering material, such as a polymer, forms a complex or coating on the surface of the anchor particles such that the tethered anchor particles have an affinity for the activated fines. In embodiments, the selection of tether and activator materials is intended to make the solids in the two streams complementary so that the activated fine particles become tethered, linked or otherwise attached to the anchor particles. When attached to activated fine particles via tethering, the anchor particles enhance the rate and completeness of sedimentation or removal of the fine particles from the fluid stream.

In accordance with these systems and methods, the tethering material acts as a complexing agent to affix the activated particles to an anchor material. In embodiments, a tethering material can be any type of material that interacts strongly with the activating material and that is connectable to an anchor particle.

As used herein, the term “anchor particle” refers to a particle that facilitates the separation of fine particles. Generally, anchor particles have a density that is greater than the liquid process stream. For example, anchor particles that have a density of greater than 1.3 g/cc can be used. Additionally or alternatively, the density of the anchor particles can be greater than the density of the fine particles or activated particles. Alternatively, the density is less than the dispersal medium, or density of the liquid or aqueous stream. Alternatively, the anchor particles are simply larger than the fine particles being removed. In embodiments, the anchor particles are chosen so that, after complexing with the fine particulate matter, the resulting complexes can be removed via a skimming process rather than a settling-out process, or they can be readily filtered out or otherwise skimmed off. In embodiments, the anchor particles can be chosen for their low packing density or potential for developing porosity. A difference in density or particle size can facilitate separating the solids from the medium.

For example, for the removal of fines (i.e., (for example, particles between about 0.1-150 microns in diameter or particles having a mass mean diameter of less than 50 microns or particle fraction that remains with the filtrate following a filtration with, for example, a 325 mesh filter), anchor particles may be selected having larger dimensions, e.g., a mass mean diameter of greater than 70 microns. An anchor particle for a given system can have a shape adapted for easier settling when compared to the target particulate matter: spherical particles, for example, may advantageously be used as anchor particles to remove particles with a flake or needle morphology. In other embodiments, increasing the density of the anchor particles may lead to more rapid settlement. Alternatively, less dense anchors may provide a means to float the fine particles, using a process to skim the surface for removal. In this embodiment, one may choose anchor particles having a density of less than about 0.9 g/cc, for example, 0.5 g/cc, to remove fine particles from an aqueous process stream.

Suitable anchor particles can be formed from organic or inorganic materials, or any mixture thereof. Particles suitable for use as anchor particles can include organic or inorganic particles, or mixtures thereof. In referring to an anchor particle, it is understood that such a particle can be made from a single substance or can be made from a composite. Any combination of inorganic or organic anchor particles can be used. Anchor particle combinations can be introduced as mixtures of heterogeneous materials. Anchor particles can be prepared as agglomerations of heterogeneous materials, or other physical combinations thereof.

In accordance with these systems and methods, inorganic anchor particles can include one or more materials such as calcium carbonate, dolomite, calcium sulfate, kaolin, talc, titanium dioxide, sand, diatomaceous earth, aluminum hydroxide, silica, other metal oxides and the like. In embodiments, the coarse fraction of the solids recovered from the mining process itself can be used for anchor particles, for example, coal from coal mining. Organic particles can include one or more materials such as biomass, starch, modified starch, polymeric spheres (both solid and hollow), and the like. Particle sizes useful as anchor particles can range from a few nanometers to few hundred microns. In certain embodiments, macroscopic particles in the millimeter range may be suitable as anchor particles. In embodiments, a particle useful as an anchor particle, such as an amine-modified particle, can comprise materials such as lignocellulosic material, cellulosic material, minerals, vitreous material, cementitious material, carbonaceous material, plastics, elastomeric materials, and the like.

Further examples of inorganic particles useful as anchor particles include clays such as attapulgite and bentonite. In embodiments, the inorganic compounds can be vitreous materials, such as ceramic particles, glass, fly ash and the like. The particles useful as anchor particles may be solid or may be partially or completely hollow. For example, glass or ceramic microspheres may be used as anchor particles. Vitreous materials such as glass or ceramic may also be formed as fibers to be used as anchor particles. Cementitious materials may include gypsum, Portland cement, blast furnace cement, alumina cement, silica cement, and the like. Carbonaceous materials may include carbon black, graphite, carbon fibers, carbon microparticles, and carbon nanoparticles, for example carbon nanotubes.

Anchor particle sizes (as measured as a mean diameter) can have a size up to few hundred microns, preferably larger than the diameter of the fine particles (e.g., greater than about 70 microns). In certain embodiments, macroscopic anchor particles up to and greater than about 1 mm may be suitable. Recycled materials or waste, particularly recycled materials and waste having a mechanical strength and durability suitable to produce a product useful in building roads and the like, or (in other embodiments) capable of combustion, are particularly advantageous.

Tethering materials can be used to coat or otherwise treat the surfaces of anchor particles. Anchor particles can be complexed with tethering agents, such agents being selected so that they interact with the polymers used to activate the fines. In one example, partially hydrolyzed polyacrylamide polymers can be used to activate particles, resulting in a particle with anionic charge properties. A cationically charged tether affixed to the anchor particles will attract the anionic charge of the activated particles, to attach the anchor particles to the activated fine particles. As an example of a tethering material used with an anchor particle in accordance with these systems and methods, chitosan can be precipitated onto sand particles, for example, via pH-switching behavior. In embodiments, various interactions such as electrostatic, hydrogen bonding or hydrophobic behavior can be used to affix an activated particle or particle complex to a tethering material complexed with an anchor particle.

In embodiments, the anchor particles can be combined with a polycationic polymer, for example, a polyamine. One or more populations of anchor particles may be used, each being activated with a tethering agent selected for its attraction to the activated fines and/or to the other anchor particle's tether. The tethering functional group on the surface of the anchor particle can be from modification using a multifunctional coupling agent or a polymer. The multifunctional coupling agent can be an amino silane coupling agent as an example. These molecules can bond to an anchor particle's surface and then present their amine group for interaction with the activated fines. In the case of a tethering polymer, the polymer on the surface of the anchor particles can be covalently bound to the surface or interact with the surface of the anchor particle and/or fiber using any number of other forces such as electrostatic, hydrophobic, or hydrogen bonding interactions. In the case that the polymer is covalently bound to the surface, a multifunctional coupling agent can be used such as a silane coupling agent. Suitable coupling agents include isocyano silanes and epoxy silanes as examples. A polyamine can then react with an isocyano silane or epoxy silane for example. Polyamines include polyallyl amine, polyvinyl amine, chitosan, and polyethylenimine.

In embodiments, polyamines (polymers containing primary, secondary, tertiary, and/or quaternary amines) can also self-assemble onto the surface of the particles or fibers to functionalize them without the need of a coupling agent. For example, polyamines can self-assemble onto the surface of the particles through electrostatic interactions. In embodiments, the amines or a majority of amines are charged. Some polyamines, such as quaternary amines are fully charged regardless of the pH. Other amines can be charged or uncharged depending on the environment. The polyamines can be charged after addition onto the particles by treating them with an acid solution to protonate the amines. In embodiments, the acid solution can be non-aqueous to prevent the polyamine from going back into solution in the case where it is not covalently attached to the particle.

In embodiments, polymers such as linear or branched polyethyleneimine can be used as tethering materials. It would be understood that other anionic or cationic polymers could be used as tethering agents, for example polydiallyldimethylammonium chloride (poly(DADMAC)). In other embodiments, cationic tethering agents such as epichlorohydrin dimethylamine (epi/DMA), styrene maleic anhydride imide (SMAI), polyethylene imide (PEI), polyvinylamine, polyallylamine, amine-aldehyde condensates, poly(dimethylaminoethyl acrylate methyl chloride quaternary) polymers and the like can be used. Advantageously, cationic polymers useful as tethering agents can include quaternary ammonium or phosphonium groups. Advantageously, polymers with quaternary ammonium groups such as poly(DADMAC) or epi/DMA can be used as tethering agents. In other embodiments, polyvalent metal salts (e.g., calcium, magnesium, aluminum, iron salts, and the like) can be used as tethering agents. In other embodiments cationic surfactants such as dimethyldialkyl(C8-C22) ammonium halides, alkyl(C8-C22) trimethylammonium halides, alkyl(C8-C22) dimethylbenzylammonium halides, cetyl pyridinium chloride, fatty amines, protonated or quaternized fatty amines, fatty amides and alkyl phosphonium compounds can be used as tethering agents. In embodiments, polymers having hydrophobic modifications can be used as tethering agents.

The efficacy of a tethering material, however, can depend on the activating material. A high affinity between the tethering material and the activating material can lead to a strong and/or rapid interaction there between. A suitable choice for tether material is one that can remain bound to the anchor surface, but can impart surface properties that are beneficial to a strong complex formation with the activator polymer. For example, a polyanionic activator can be matched with a polycationic tether material or a polycationic activator can be matched with a polyanionic tether material.

In hydrogen bonding terms, a hydrogen bond donor should be used in conjunction with a hydrogen bond acceptor. In embodiments, the tether material can be complementary to the chosen activator, and both materials can possess a strong affinity to their respective deposition surfaces while retaining this surface property. In other embodiments, cationic-anionic interactions can be arranged between activated fines and tether-bearing anchor particles. The activator may be a cationic or an anionic material, as long as it has an affinity for the fine particles to which it attaches. The complementary tethering material can be selected to have affinity for the specific anchor particles being used in the system. In other embodiments, hydrophobic interactions can be employed in the activation-tethering system.

### 2. Hydrophobic ATA

Modifications to improve the hydrophobicity of ATA solids can involve the addition of hydrophobizing materials at any stage of the ATA process, whether involving activation, tethering, or the anchor particles themselves. Hydrophobizing materials can include hydrophobic substrates to be used for or with anchor particles, or hydrophobizing substances to be added during any step of the ATA process. As used herein, the term “hydrophobic” refers to a molecular entity that tends to be non-polar and, thus, prefers other neutral molecules and non-polar solvents. Examples of hydrophobic molecules include the alkanes, oils, fats, silanes, fluorocarbons, and the like. As used herein, the term “hydrophobization” means to render a substrate, a process, etc., hydrophobic. The terms “hydrophobization” and “hydrophobicization,” and the terms “hydrophobizing material” and “hydrophobicizing material” are used interchangeably.

Hydrophobizing materials can include hydrophobic substrates to be used for or with anchor particles, or hydrophobizing substances to be added during any step of the ATA process. Hydrophobizing materials can comprise hydrophobic small molecules or hydrophobic polymers. Examples of suitable hydrophobizing molecules include fatty acids and fatty acid salts. As used herein, the term “fatty acid” refers to a carboxylic acid having a hydrocarbon chain of 4-36 carbons, where the chain can be fully saturated and unbranched, or where there can be one or more points of unsaturation, optionally bearing other functional groups including three-carbon rings or hydroxyl group. Exemplary fatty acids useful for hydrophobic modification of particles include fatty acids (and their salts) such as stearic acid, sodium stearate, oleic acid, sodium oleate, lauric acid, sodium laurate, and the like. Additionally, fatty amines, surfactants, detergents, ethoxylated surfactants, nonionic surfactants, and the like, can be used.

In other embodiments, a variety of hydrophobic polymers and copolymers can be used as hydrophobizing materials, including those comprising hydrophobic acrylics, amides and imides, carbonates, dienes, esters, ethers, fluorocarbons, olefins, styrenes, vinyl acetals, vinyl and vinylidine chlorides, vinyl ethers and ketones, vinylpyridine and vinylpyrrolidone, and the like. Examples of suitable hydrophobic polymers include, by way of example and not of limitation, those polymers that are formed by polymerization of α,β-ethylenically unsaturated monomers or olefinic polymerization. Polymers obtained by polymerization of α,β-ethylenically unsaturated monomers include but are not limited to polymers and copolymers obtained from polymerizable amide compounds including acrylamide, N-(1,1-Dimethyl-3-oxobutyl)-acrylamide, N-alkoxy amides such as methylolamides; N-alkoxy acrylamides such as n-butoxy acrylamide; N-aminoalkyl acrylamides or methacrylamides such as aminomethylacrylamide, 1-aminoethyl-2-acrylamide, 1-aminopropyl-2-acrylamide, 1-aminopropyl-2-methacrylamide, N-1-(N-butylamino)propyl-(3)-acrylamide and 1-aminohexyl-(6)acrylamide and 1-(N,N-dimethylamino)-ethyl-(2)-methacrylamide, 1-(N,N,dimetnylamino)-propyl-(3)-acrylamide and 1-(N,N-dimethylamino)-hexyl-(6)-methacrylamide; polymerizable nitriles such as acrylonitrile and methacrylonitrile; polyalkylene glycol acrylates and methacrylates such polyethylene glycol substituted acrylate and methacrylate; alkyl acrylates or alkyl methacrylates such as methyl acrylate, methyl methacrylate, ethyl acrylate, ethyl methacrylate, n-butyl acrylate, n-butyl methacrylate, 2-ethylhexyl acrylate, cyclohexyl methacrylate, 2-ethylhexyl methacrylate, isobornyl methacrylate, stearyl methacrylate, sulfoethyl methacrylate and lauryl methacrylate; polymerizable aromatic compounds including styrene, α-methyl styrene, vinyl toluene, t-butyl styrene; α-olefin compounds such as ethylene, propylene; vinyl compounds such as vinyl acetate, vinyl propionate, vinyl ethers, vinyl and vinylidene halides, diene compounds such as butadiene and isoprene. Other hydrophobic polymers can be formed to include fluorine or silicon atoms. Examples of these include 1H, 1H, 5H-octafluoropentyl acrylate, and trimethylsiloxyethyl acrylate.

Other hydrophobic polymers include polyalkylene homopolymers, polyalkylene copolymers or polyalkylene block copolymers. Such compounds can be polymerized from olefins selected from the group consisting of ethylene, propylene, butylene, and mixtures thereof. By way of example and not of limitation, exemplary hydrophobic polymers can include polyacetals, polyolefins, polycarbonates, polystyrenes, polyesters, polyamides, polyamideimides, polyarylates, polyarylsulfones, polyethersulfones, polyphenylene sulfides, polyvinyl chlorides, polysulfones, polyimides, polyetherimides, polytetrafluoroethylenes, polyetherketones, polyether etherketones, polyether ketone ketones, polybenzoxazoles, polyphthalimides, polyanhydrides, polyvinyl ethers, polyvinyl thioethers, polyvinyl ketones, polyvinyl halides, polyvinyl nitriles, polyvinyl esters, polysulfonates, polysulfides, polythioesters, polysulfonamides, polyureas, polyphosphazenes, polysilazanes, polyethylene terephthalate, polybutylene terephthalate, polyurethane, polytetrafluoroethylene, polychlorotrifluoroethylene, polyvinylidene fluoride, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polypyrrolidines, polycarboranes, polyoxabicyclononanes, polydibenzofurans, and polysiloxanes, or combinations thereof.

Hydrophobizing substances can be added to the fines directly to create more hydrophobic fines for subsequent activation. Hydrophobizing substances can be added as part of the activation step, with hydrophobic polymers being used as main activators, or as adjuncts to activators. In embodiments, activator polymers with hydrophobic modifications can be used. Polymers having hydrophobic modifications include polymers and copolymers formed by incorporating hydrophobic monomers in the polymeric chain. Examples of activator polymers with hydrophobic modifications can include PEO-PPO copolymers, hydrophobically modified polyacrylamide or polyacrylates, hydrophobic alkali-soluble emulsions (HASE) polymers, and the like. When the hydrophobic material is added to the fines and agitated, it will preferentially bind to the suspended fines and cause them to be hydrophobic. When the activated hydrophobic fines come into contact with the tethered coarse particles, all solids will have a hydrophobic character. Hydrophobizing substances can also be added after activation takes place, so that the activated fines are rendered more hydrophobic.

In embodiments, hydrophobizing substances can be added to the anchor particles milieu, for example as part of the coarse solids slurry that provides the anchor particles. Hydrophobizing substances can be used as tether polymers or as adjuncts to the tethering process. In embodiments, polymers having hydrophobic modifications can be used as tethering agents, for example, polyethylene oxide—polypropylene oxide copolymers, hydrophobically modified polyacrylamide or polyacrylates, hydrophobic alkali-soluble emulsions (HASE) polymers, and the like. Hydrophobizing substances can be added after the tethering takes place, so that the tether-bearing anchor particles are rendered more hydrophobic.

Hydrophobizing materials can be added to the ATA solids that are formed after the consolidation of the activated fines and the tether-bearing anchor particles, so that the final solids become and/or remain more hydrophobic. Any of these hydrophobizing steps can be undertaken alone or in combination with the others.

If a hydrophobizing material has been applied either to the fines side of the process or to the anchor particles side of the process, it will ultimately be captured in the final ATA composite: when the activated, insoluble fines come into contact with the tether-bearing anchor particles, the resultant ATA solids will incorporate hydrophobic properties. Such ATA solids can be termed a “hydrophobized composite.” As the hydrophobic solids flocculate and drain, more water will be removed than in traditional ATA or other dewatering processes. Once ATA solids are used in the desired application, a hydrophobic material can be applied at desired intervals of time for an initial application, or reapplication, of a hydrophobic coating.

Hydrophobic materials that are advantageous for providing a hydrophobic coating on ATA solids can include organoclay, hydrophobic starch, naphthenic acid, humic acid, lanolin, acrylic paint binders, waxes, oils, or other materials with a nonpolar chemical makeup.

In general terms, any hydrophobic polymeric material that is soluble or partially soluble before addition to the tailings and become insoluble after addition to the tailings and interaction with the particles can be used to create a hydrophobic ATA material. In embodiments, polymers with upper or lower critical solution temperatures can be used. As an example, when a polymer with an upper critical solution temperature of 30 degrees Celsius is heated above 30 degrees, the polymer is soluble. When it is added to fine tailings that are around room temperature (˜23 degrees Celsius), the polymer will begin to become insoluble and will preferentially bind to the suspended fines and cause them to be more hydrophobic. In embodiments, polymers with an upper or lower critical solution temperatures such as poloxamers, polyacrylamides, poly vinyl caprolactams, cellulose, xyloglucan, chitosan, and acrylate copolymers can be used. In embodiments, polymers that are soluble in solvents of certain pH levels and insoluble in others can be used. If a polymer is alkali-soluble and is added as a basic solution to tailings with a neutral or slightly acidic pH, the polymer will begin to become insoluble, and will preferentially bind to the suspended fines and cause them to be more hydrophobic. In embodiments, any polymer that contains both a nonpolar component or side group and a polar component or side group can be used. Polymers whose solubility is affected by pH include maleic anhydride copolymers, poly methacrylic acids, polyvinylpyridines, and polyvinylimidazoles. Additionally, co-polymers of acrylic acid or acrylates with more hydrophobic repeat units can be used. As an example, a copolymer of lauryl acrylate and acrylic acid salt can be used. More specific descriptions of hydrophobizing materials and methods for their use are provided below.

a. Emulsions

Emulsions containing hydrophobic materials, such as waxes, latexes, or drying oils can be used to create a hydrophobic material, as an emulsion will be able to mix into aqueous solution easily. Combining the emulsion with a particulate stream can render the particles hydrophobic, for example by intense mixing or breaking the emulsion after addition. When the emulsion is broken, the hydrophobic portion can attach to particles or aggregates and render them hydrophobic. When the hydrophobic activated fines are subsequently mixed with the tether-bearing anchor particles via the ATA process, the resulting consolidated solids will have an increased hydrophobic nature. As these hydrophobic solids aggregate and drain, more water will be removed from them than in traditional ATA or other dewatering processes. Once ATA solids are formed, additional hydrophobization can be achieved by applying a coating of the initial hydrophobic emulsion or other hydrophobic coating at desired intervals of time. If an emulsion is used, the emulsion itself can be applied, and the hydrophilic portion can be evaporated, or the emulsion can be broken and applied. Any material found within hydrophobic emulsions such as are disclosed herein can also be applied alone in a non-emulsion form.

In embodiments, hydrophobizing emulsions can be formed using drying oils, such as linseed oil emulsions, boiled linseed oil emulsions, tung oil emulsions, poppy seed oil emulsions, perilla oil emulsions, walnut oil emulsions, or other emulsions containing oils with glycerol triesters of fatty acids. Drying oils harden through crosslinking, which can be advantageous to producing solids with a higher solids content. In other embodiments, suitable emulsions can be formed such as paraffin wax emulsions, polyethylene wax emulsions, polypropylene wax emulsions, latex rubber emulsions, styrene-butadiene rubber emulsions, asphalt rubber emulsions, silicone emulsions, beeswax emulsions, carnauba wax emulsions, or other emulsions based on natural waxes, synthetic waxes, or other hydrophobic polymers.

b. Hydrophobic particles

Hydrophobic particles can be added to the fines stream or the anchor particles stream or both, to make the specified stream more hydrophobic. Hydrophobic particles can be used as additives to the selected stream to increase its hydrophobicity and the hydrophobicity of the resultant ATA solid. Hydrophobic particles can also be used as anchor particles, to be coated with a tethering polymer with or without additional hydrophobization, to increase the hydrophobicity of that stream and the hydrophobicity of the resultant ATA solid.

In embodiments, intrinsically hydrophobic particles can be used as anchor particles or as adjuncts to the ATA system to be embedded in the consolidated ATA solid mass. For example, plastic materials may be used as hydrophobic particles. Both thermoset and thermoplastic resins may be used to form suitable plastic particles. Plastic particles may be shaped as solid bodies, hollow bodies or fibers, or any other suitable shape. Plastic particles can be formed from a variety of polymers. A polymer useful as a plastic particle may be a homopolymer or a copolymer. Copolymers can include block copolymers, graft copolymers, and interpolymers. In embodiments, suitable plastics may include, for example, addition polymers (e.g., polymers of ethylenically unsaturated monomers), polyesters, polyurethanes, aramid resins, acetal resins, formaldehyde resins, and the like. Addition polymers can include, for example, polyolefins, polystyrene, and vinyl polymers. Polyolefins can include, in embodiments, polymers prepared from C₂-C₁₀ olefin monomers, e.g., ethylene, propylene, butylene, dicyclopentadiene, and the like. In embodiments, poly(vinyl chloride) polymers, acrylonitrile polymers, and the like can be used. In embodiments, useful polymers for the formation of particles may be formed by condensation reaction of a polyhydric compound (e.g., an alkylene glycol, a polyether alcohol, or the like) with one or more polycarboxylic acids. Polyethylene terephthalate is an example of a suitable polyester resin. Polyurethane resins can include polyether polyurethanes and polyester polyurethanes. Plastics may also be obtained for these uses from waste plastic, such as post-consumer waste including plastic bags, containers, bottles made of high density polyethylene, polyethylene grocery store bags, and the like. In embodiments, elastomeric materials can be used as particles. Particles of natural or synthetic rubber can be used, for example.

In embodiments, a particle with or without intrinsic hydrophobicity can be made hydrophobic and then used to increase the hydrophobicity of the ATA solid. In embodiments, the substrate particle for hydrophobic modification can include any organic or inorganic particles, or mixtures thereof, modified to increase their hydrophobicity. The substrate particles can be modified prior to introduction into the process, at the point of injection, or after injection. The hydrophobically modified particles can be added either to the activation side of the process or the tether-bearing anchor particles side of the process. Incorporation of the hydrophobically modified particles within the final ATA solid will lead to a more hydrophobic final product, which will consolidate more quickly because it repels water, and it will produce more efficient water retrieval. Moreover, the final ATA solid will be more resistant to subsequent water incursion, a property that can be improved by additional treatment of the final ATA solid with a hydrophobizing material.

A wide range of materials would be suitable for hydrophobic modification of particles, as would be understood by those of ordinary skill in the art. In embodiments, fatty acids and fatty acid salts such as stearic acid, sodium stearate, oleic acid, sodium oleate, lauric acid, sodium laurate, and the like, can be used. Additionally, fatty amines, surfactants, detergents, ethoxylated surfactants, nonionic surfactants, and the like, can be used. In other embodiments, a variety of hydrophobic polymers and copolymers can be used, including those comprising hydrophobic acrylics, amides and imides, carbonates, dienes, esters, ethers, fluorocarbons, olefins, styrenes, vinyl acetals, vinyl and vinylidine chlorides, vinyl ethers and ketones, vinylpyridine and hynlypyrrolidone, and the like.

In embodiments, for example, a particle such as precipitated calcium carbonate (PCC) can be coated with a hydrophobizing agent such as stearic acid, thereby creating hydrophobically modified PCC particles. In embodiments, these hydrophobically modified PCC particles can be used as anchor particles, to be complexed with an appropriate tethering agent. In other embodiments, these hydrophobically modified PCC particles can be used in conjunction with other anchor particles, all of which can be combined with appropriate tethering polymers to form a composite set of tether-bearing anchor particles. In yet other embodiments, the hydrophobically modified PCC particles can be added to the fine particulates, either before or after their activation, thus rendering the fine particulate dispersion more hydrophobic. When the tether-bearing anchor particles are added to this hydrophobized activated fine particulate dispersion, an ATA solid will form that has hydrophobic properties.

In embodiments, any organic or inorganic particle can be used as a substrate particle for hydrophobizing. For example, the materials mentioned above for use as anchor particles may provide suitable substrates for hydrophobizing.

c. Hydrophobic post-treatment

Instead of or in addition to forming ATA solids using one or more hydrophobizing steps, as described above, hydrophobic materials can be added to ATA solids after they are formed. Hydrophobic materials as described above can be suitable for such hydrophobic post-treatment processes. In embodiments, large quantities of hydrophobic materials can be incorporated into the final treatment steps for the waste materials, so that the final layer that is formed has hydrophobic properties and can act as a hydrophobic shell for the entire mass of previously-produced waste materials. In other embodiments, a hydrophobic material can be applied to the stack of waste solids, to provide hydrophobic protection to the entire pile.

### 3. Exemplary Application: Controlling Acid Mine Drainage

In embodiments, the systems and methods disclosed herein can be used for any waste treatment where faster consolidation of the ATA solid is desirable, or where greater water-resistance of the ATA solid is advantageous. For example, in the treatment of acid mine drainage (AMD), an ATA process can be used to consolidate the mine tailings with the incorporation of a controlled release base formulation, as disclosed in U.S. Provisional Patent Application Ser. No. 62/320,786, filed Apr. 11, 2016, the contents of which are incorporated herein by reference.

As described above, a hydrophobizing step can be included as part of the ATA process, which would render the final ATA solid more hydrophobic. Treating mine tailings in this way can be used as a method to control AMD as well, because if the ATA solid is more resistant to moisture (because it is more hydrophobic), any acidic substances or acid-producing moieties entrained therein would be shielded from release into the environment. In certain embodiments, using the hydrophobic ATA process alone would offer useful control of AMD, because the acidic components of the ATA solid would be protected from water contact so would remain trapped within the solid material. In other embodiments, a hydrophobizing step as described herein can be added to the ATA process in combination with other treatment processes for AMD, for example the use of a controlled release base formulation to neutralize the acid species.

In addition to limiting the acid producing potential of the resultant solids by reducing the inherent moisture content, the hydrophobic nature of the ATA solids can decrease the environmental effects of AMD by slowing the rate by which acidity is released from the ATA composite. In embodiments, the hydrophobic component of the ATA solids can slowly degrade via hydrolysis. As the hydrophobic component degrades, the underlying ATA particles can become exposed to the surrounding environment, allowing the gradual neutralization of any produced acid. For example, hydrophobically modified PCC can be used in this manner. The PCC particles modified with a hydrophobic coating can be engineered so that they degrade under acidic conditions. Further, the hydrophobic coating on particles such as PCC can be tuned so that the coating and/or the underlying particle can release acid neutralizing species at a controlled rate regardless of the pH of the environment.

### EXAMPLES

### Example 1: Preparation of Material Using Anchor Particles, Tethering, and Activation (ATA) Process

A control material is prepared using a process that includes activation, tethering, and use of anchor particles (the ATA process). The process is commenced by introducing 400 ppm of activator polymer (active polymer per dry solids in the tailings), for example, high molecular weight polyacrylamides and modified polyacrylamides, such as high molecular weight anionic polyacrylamides, into a container with a predetermined amount of fine tailings obtained from mining wastewater. The fine tailings and activator polymer are mixed by inverting the container six times. A separate predetermined amount of coarse tailings obtained from mining wastewater is treated with 200 ppm of tether polymer (active polymer per dry solids in the tailings), for example high molecular weight cationic polymers such as poly(DADMAC) polymers and cationic polyacrylamides, and is mixed or shaken for a few seconds, allowing the tether polymer to coat the coarse tailings. Both the activator and the tether polymer solutions are created using 0.1% solutions of polymer actives in water. The activated fines are added to the tether-coated coarse tailings material, and the container is inverted six times. The contents of the container are then poured onto a Buchner funnel fitted with a 70 mesh screen, where the resulting solids are collected on the screen and clarified water drains through. A portion of the screened solids are then pressed between paper towels to simulate further dewatering. The solids contents of the gravity drained and pressed samples are measured with a moisture balance. The solids content of the pressed samples is expected to exceed the solids content of the gravity drained samples.

Hydrophobicity of the resulting material can be assessed in a number of ways. Moisture contact can be measured, or the materials can be tested visually or instrumentally. Contact angle for water droplets on the samples can provide a measure of hydrophobicity: when a drop of water is dropped on pressed samples, the experimental sample has a larger contact angle when visually inspected.

### Example 2: Addition of Hydrophobic Substances to Fine Tailings

An experimental material is prepared in the same manner as the control material described in Example 1, but an anionic paraffin/ethylene acrylic acid wax emulsion plus sulfuric acid is added in with the fines before the activator polymer is added. The amount of wax emulsion solids added is three percent of the amount of fines solids. Four percent sulfuric acid based on the emulsion is added and mixed, preferably after the emulsion has been added. The sulfuric acid breaks the emulsion, and it can then be added into the fines and agitated. A 400 ppm dosage of activator polymer is added to the wax-containing fines and inverted six times, a 200 ppm dosage of the tether polymer is added to the coarse and inverted six times, and the activated fines are then added to the tether-coated coarse material and again inverted six times. The draining and drying processes are the same as for the control situation.

The hydrophobicity of the emulsion-treated sample is expected to exceed that of the control ATA material. It is also expected that the solids content of the experimental sample would exceed that of the control ATA material. Visually, the gravity drained and pressed experimental solids would not to hold as much water as the control does. In addition, when a drop of water is dropped on pressed samples, the experimental sample would have a larger contact angle when visually inspected. These findings would lead to the conclusion that the experimental sample is more hydrophobic.

### Example 3: Preparation of Hydrophobic Precipitated Calcium Carbonate

Two hydrophobic precipitated calcium carbonate (PCC) samples are created. The first is created using 20 grams of PCC, 0.422 grams of stearic acid, and 45 mL of hexane. The stearic acid is first added to and mixed with the hexane. The PCC is then added to the mixture and mixed at 50 degrees Celsius for 30 minutes. The mixture is cooked in an oven for two hours at 120 degrees Celsius. Once the sample is removed from the oven, the cake is broken up into a powder that resembles the original PCC. Another hydrophobic PCC sample is created using 20 grams of PCC, 0.422 grams of oleic acid, and 45 mL of water. The PCC is added to the water at 75 degrees Celsius and agitated, and the oleic acid is then added. The mixture is agitated for 30 minutes. It is then cooked and broken up just as the stearic acid PCC is.

### Example 4: Addition of Hydrophobic PCC to Fine Tailings

For each experiment, a hydrophobic PCC sample prepared in accordance with Example 3 is added as an adjunct to the activation step of the ATA process described in Example 1. The amount of hydrophobic PCC added to the fines is five percent of the solids content of the fines, and this mixture is agitated. A 400 ppm dosage of activator polymer is added to the PCC-containing fines and inverted six times. A 200 ppm dosage of the tether polymer is added to the coarse material and inverted six times, and the fines are then added to the coarse and again inverted six times. The draining and drying processes are the same as explained for the control situation.

The hydrophobicity of all the experimental samples is expected to exceed that of the control ATA material. It is also expected that the solids content of the experimental sample would exceed that of the control ATA material. Visually, the gravity drained and pressed experimental solids would not to hold as much water as the control does. In addition, when a drop of water is dropped on pressed samples, the experimental sample would have a larger contact angle when visually inspected. These findings would lead to the conclusion that the experimental sample is more hydrophobic.

### Example 5: Addition of Certain Hydrophobic Substances to Fine Tailings

Hydrophobic substances can be added to fine tailings to induce hydrophobicity in a final product formed using the ATA process. Hydrophobic substances can be tested, for example organoclay, hydrophobic starch, naphthenic acid/humic acid (hydrophobic in hard water, becomes divalent), lanolin, and acrylic paint binder. Experiments using these hydrophobic substances can be performed as follows.

For a first experimental material, it can be prepared in accordance with the general ATA process of Example 1, but organoclay is added in with the fines before the activator is added. The amount of organoclay added is ten percent of the amount of fines solids. The mixture is agitated, and a 400 ppm dosage of activator polymer is added to the wax-containing fines and inverted six times, a 200 ppm dosage of the tether polymer is added to the coarse and inverted six times, and the fines are then added to the coarse and again inverted six times. The material is drained and dried as described in Example 1. The solids contents of the gravity drained and pressed samples are measured with a moisture balance.

A second experimental material can be prepared in accordance with the general ATA process of Example 1, but a naphthenic acid emulsion is added (500 PPM on a dry solids basis) in with the fines before the activator is added. The emulsion can be broken by either high shear mixing or adding a demulsifier, which allows the naphthenic acid to interact with the surface of the fines. The mixture is agitated, and a 400 ppm dosage of activator polymer is added to the naphthenic acid-containing fines and inverted six times, a 200 ppm dosage of the tether polymer is added to the coarse and inverted six times, and the fines are then added to the coarse and again inverted six times. The material is drained and dried as described in Example 1. The solids contents of the gravity drained and pressed samples are measured via a moisture balance.

Results with the experimental materials are compared with the control material prepared according to Example 1. With either experimental material, the hydrophobicity of the treated sample exceeds that of the control. The hydrophobicity of all the experimental samples is expected to exceed that of the control ATA material. It is also expected that the solids content of the experimental sample would exceed that of the control ATA material. Visually, the gravity drained and pressed experimental solids would not to hold as much water as the control does. In addition, when a drop of water is dropped on pressed samples, the experimental sample would have a larger contact angle when visually inspected. These findings would lead to the conclusion that the experimental sample is more hydrophobic.

### Example 6: Addition of Polymeric Substances to Fine Tailings that Become Hydrophobic

Substances can be added to fine tailings that become hydrophobic, thereby inducing hydrophobicity in a final product formed using the ATA process. Such substances can include substances having a favorable upper critical solution temperature or lower critical solution temperature, materials that are pH changing such as styrene maleic anhydride, acrylate copolymers, and the like. Experiments using these substances can be performed as follows.

A first experimental material (Sample A) can be prepared in accordance with the ATA process of Example 1, but poly(n-butyl acrylate/acrylic acid) (50:50) is added in with the fines before the activator is added. The amount added is one percent polymer to the amount of fines solids. The mixture is agitated, and a 400 ppm dosage of activator polymer is added to the wax-containing fines and inverted six times, a 200 ppm dosage of the tether polymer is added to the coarse and inverted six times, and the fines are then added to the coarse and again inverted six times. The material is drained and dried as described in Example 1.

In a second experiment (Sample B), the ATA process of Example 1 is modified by mixing poly(n-butyl acrylate/acrylic acid) with the activator polymer in a 1:1 ratio by actives (on a dry mass basis) and 500 ppm of this activator formulation is added to the fines and inverted six times. A 200 ppm dosage of the tether polymer is added to the coarse and inverted six times, and the fines are then added to the coarse and again inverted six times. The draining and drying processes are the same as explained for the control situation.

In a third experiment (Sample C), the ATA process of Example 1 is performed using 1,000 ppm of the poly(n-butyl acrylate/acrylic acid) as the activator polymer to the fines and inverted six times. A 200 ppm dosage of the tether polymer is added to the coarse and inverted six times, and the fines are then added to the coarse and again inverted six times The material is drained and dried as described in Example 1.

Results with the experimental Samples A, B, and C are compared with the control material prepared according to Example 1. With each experiment, the hydrophobicity of the poly(n-butyl acrylate/acrylic acid)-treated sample exceeds that of the control ATA material. It is also expected that the solids content of the experimental sample would exceed that of the control ATA material. Visually, the gravity drained and pressed experimental solids would not to hold as much water as the control does. In addition, when a drop of water is dropped on pressed samples, the experimental sample would have a larger contact angle when visually inspected. These findings would lead to the conclusion that the experimental sample is more hydrophobic.

While specific embodiments of the subject invention have been discussed, the above specification is illustrative and not restrictive. Many variations of the invention will become apparent to those skilled in the art upon review of this specification. Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth herein are approximations that can vary depending upon the desired properties sought to be obtained by the present invention.

While this invention has been particularly shown and described with references to preferred embodiments thereof, it will be understood by those skilled in the art that various changes in form and details may be made therein without departing from the scope of the invention encompassed by the appended claims.

1. A method of removing particulate matter from a fluid as a hydrophobized composite, comprising:
providing an activating material capable of being affixed to the particulate matter wherein the activating material is an anionic or a cationic polymer;
affixing the activating material to the particulate matter to form activated particles in the fluid;
providing anchor particles and providing a tethering material capable of being affixed to the anchor particles, wherein the tethering material is a cationic or an anionic polymer;
attaching the tethering material to the anchor particles to form tether-bearing anchor particles and adding the tether-bearing anchor particles to the fluid, wherein the tethering material attaches to the activated particles to form removable complexes in the fluid;
removing the removable complexes from the fluid, thereby removing the particulate matter from the fluid; and
adding a hydrophobizing material at one or more of the preceding steps, thereby removing the particulate matter from the fluid as the hydrophobized composite.

2. The method of claim 1, wherein the hydrophobizing material is added to the fluid prior to the step of affixing the activating material.

3. The method of claim 1, wherein the hydrophobizing material is added to the activating material.

4. The method of claim 1, wherein the hydrophobizing material is added to the activated particles after their formation.

5. The method of claim 1, wherein the hydrophobizing material comprises hydrophobic particles.

6. The method of claim 5, wherein the hydrophobic particles are used as anchor particles.

7. The method of claim 5, wherein the hydrophobic particles are intrinsically hydrophobic.

8. The method of claim 5, wherein the hydrophobic particles comprise a substrate having a hydrophobic modification.

9. The method of claim 8, wherein the substrate comprises calcium carbonate.

10. The method of claim 9, wherein the calcium carbonate is a precipitated calcium carbonate.

11. The method of claim 1, wherein the hydrophobizing material is added to the fluid prior to the step of adding the tether-bearing anchor particles.

12. The method of claim 1, wherein the hydrophobizing material is added to the fluid at substantially the same time as the tether-bearing anchor particles are added.

13. The method of claim 1, wherein the hydrophobizing material is added to the fluid after the addition of the tether-bearing anchor particles.

14. The method of claim 1, wherein the hydrophobizing material is added to the removable complexes before, during, or after their removal.

15. The method of claim 14, wherein the hydrophobizing material is added to the removable complexes after their removal as a post-treatment modification.

16. The method of claim 1, wherein the hydrophobizing material comprises an emulsion.

17. The hydrophobized composite prepared by the method of claim 1.
